(19) United States
(12) Patent Application Publication
(10) Pub. No.: US 2013/0313926 A1
(43) Pub. Date: Nov. 28, 2013

(54) Handheld power tool

(71) Applicants: Miro BEKAVAC, Korntal-Muenchingen (DE); Patrick Budaker, Heubach (DE)

(72) Inventors: Miro BEKAVAC, Korntal-Muenchingen (DE); Patrick Budaker, Heubach (DE)

(73) Assignee: Robert Bosch GmbH, Stuttgart (DE)

(21) Appl. No.: 13/901,912

(22) Filed: May 24, 2013

(30) Foreign Application Priority Data
May 25, 2012 (DE) 102012208890.3

(51) Int. Cl. H02K 7/14; H02K 11/00

(52) U.S. Cl. CPC H02K 7/145; H02K 11/0021
USPC 310/50; 310/68 B

(57) ABSTRACT

A handheld power tool having an electronically commutated drive motor which is situated in an associated housing and which has a rotor provided with a rotor shaft, in which the rotor shaft is rotatably mounted in the associated housing having an axial clearance which is based at least partially on manufacturing tolerances, and at least one position sensor magnet is rotatably fixedly mounted on the rotor shaft. The position sensor magnet is assigned a sleeve-like spacer for reducing the axial clearance.

### RELATED APPLICATION INFORMATION

The present application claims priority to and the benefit of German patent application no. 10 2012 208 890.3, which was filed in Germany on May 25, 2012, the disclosure of which is incorporated herein by reference.

### FIELD OF THE INVENTION

The present invention relates to a handheld power tool having an electronically commutated drive motor which is situated in an associated housing and which has a rotor provided with a rotor shaft, the rotor shaft being rotatably mounted in the associated housing having an axial clearance which is based at least partially on manufacturing tolerances, and at least one position sensor magnet being rotatably fixedly mounted on the rotor shaft.

### BACKGROUND INFORMATION

A handheld power tool of the type mentioned at the outset may have an electronically commutated drive motor which is situated in an associated tool and/or motor housing and in which a rotor provided with a rotor shaft is situated. The rotor, which is also referred to as an armature, generates via at least one drive magnet, which is rotatably fixedly mounted on the rotor shaft, a magnetic cross field which interacts with a magnetic excitation field, which is generated in a manner known per se and which is also referred to as a magnetic rotating field, and thus drives the rotor. To generate the magnetic rotating field, a current which feeds the drive motor must be commutated. For this purpose, a position sensor magnet is also rotatably fixedly situated on the rotor shaft in the electronically commutated drive motor of the handheld power tool mentioned at the outset.

The disadvantage of the related art is that the rotor shaft is rotatably mounted in the associated tool and/or motor housing having an axial clearance due to manufacture, in particular due to manufacturing tolerances, in order to generate a predefined distance between associated fixed and movable bearings provided to mount the rotor shaft for installation within the housing.

### SUMMARY OF THE INVENTION

One object of the present invention is therefore to provide a novel handheld power tool having an electronically commutated drive motor, which is situated in an associated housing and which has a rotor provided with a rotor shaft, the handheld power tool having an at least reduced axial clearance of the rotor shaft in the associated housing.

This object is achieved by a handheld power tool having an electronically commutated drive motor which is situated in an associated housing and which has a rotor provided with a rotor shaft. The rotor shaft is rotatably mounted in the associated housing having an axial clearance which is based at least partially on manufacturing tolerances, and at least one position sensor magnet is rotatably fixedly mounted on the rotor shaft. A sleeve-like spacer is assigned to the position sensor magnet for reducing the axial clearance.

The present invention thus makes it possible to at least reduce the axial clearance of the rotor shaft mentioned at the outset in the associated housing. In this way, it may be safely and reliably ensured that the rotor components mounted in the housing hold their positions over the service life of the handheld power tool and also in the case of axial stresses, e.g., if the handheld power tool is dropped. An axial displacement of these rotor components between associated bearing points may be safely and reliably prevented so that the rotor components permanently have a unique, predefined axial position. In this way, when using the handheld power tool having the drive motor in which the rotor shaft is mounted, mechanical noise, which is due to the axial clearance, inaccuracies during the work using the handheld power tool, and mechanical stresses on the rotor shaft as well as on the components on which the rotor shaft is mounted may be reduced.

The position sensor magnet and the sleeve-like spacer may be configured as a single piece.

The position sensor magnet and the sleeve-like spacer may thus be manufactured in one working cycle and accordingly fixedly mounted on the rotor shaft, whereby, on the one hand, a cost-effective production of the drive motor is possible at minimum average working cycle times and, on the other hand, the sleeve-like spacer is also directly fastened on the rotor shaft via the position sensor magnet.

According to one specific embodiment, the position sensor magnet, which is configured as a single piece with the sleeve-like spacer, is configured as an injection-molded part.

In this way, the position sensor magnet together with the sleeve-like spacer may be mass-produced.

According to one specific embodiment, the position sensor magnet is connected to a drive magnet, which is rotatably fixedly situated on the rotor shaft, via meshing fixing elements which have mutually matching geometric shapes.

In this way, a form-lock is achieved between the position sensor magnet and the drive magnet. Due to this form-lock, a twisting of the position sensor magnet in relation to the drive magnet is prevented and a permanently active electronic commutation of the operating current feeding the drive motor is thus ensured. Due to the fact that the position sensor magnet is rotatably fixed on the drive magnet, it is not necessary to additionally rotatably fix the position sensor magnet on the drive shaft which is often implementable only with great difficulties and for a short period of time with the aid of a press fit.

According to one specific embodiment, the position sensor magnet has at least one axially aligned protrusion which meshes with an associated, axially aligned recess provided on the drive magnet, the protrusion and the recess being the fixing elements.

In this way, a stable and reliable form-locked fastening of the position sensor magnet on the drive magnet may be enabled in a simple manner.

The axially aligned protrusion and the sleeve-like spacer may be formed on axial ends of the position sensor magnet which face away from one another.

The use of the sleeve-like spacer thus not only allows the axial clearance of the rotor shaft to be reduced, but it is rather also possible to reliably hold the axially aligned protrusion in the appropriate axially aligned recess in the drive magnet with the aid of the sleeve-like spacer due to the sleeve-like spacer axially facing away from the axially aligned protrusion, if the dimensions are suitable, so that the form-lock between the drive magnet and the position sensor magnet is permanently ensured.

According to one specific embodiment, the matching geometric shapes form a form-lock to fasten the position sensor magnet on the drive magnet in such a way that it is secured against twisting.

In this way, a safe and reliable fixing of the position sensor magnet on the drive magnet may be enabled in a simple manner.

The rotor may have an iron core on which the axially aligned recesses are formed as a type of axial pass-through opening.

These axial pass-through openings may be introduced into the iron core for material reduction purposes, e.g., to save weight and costs, and are used, in particular, for improved guidance of a magnetic flow generated by the drive magnet. By designing the axially aligned recesses in these pass-through openings, the same are advantageously also used at the same time to implement the indicated handheld power tool.

The drive magnet may be configured as a ring magnet.

In this way, the drive magnet may be manufactured using comparably little magnetic material, a sufficiently strong magnetic cross field for driving the drive motor being able to build up nevertheless in conjunction with the iron core.

Moreover, the object mentioned at the outset is also achieved by an electronically commutated drive motor which has an associated housing and a rotor provided with a rotor shaft. The rotor shaft is rotatably mounted in the associated housing having an axial clearance which is based at least partially on manufacturing tolerances, and at least one position sensor magnet is rotatably fixedly mounted on the rotor shaft. A sleeve-like spacer is assigned to the position sensor magnet for reducing the axial clearance.

The present invention is elucidated in greater detail in the following description with reference to the exemplary embodiments illustrated in the drawings.

### BRIEF DESCRIPTION OF THE DRAWINGS

FIG. 1 shows a schematic view of a handheld power tool having an insert tool according to one specific embodiment.

FIG. 2 shows a schematic view of the electronically commutated drive motor of the handheld power tool from FIG. 1.

FIG. 3 shows a first perspective view of the position sensor magnet unit from FIG. 2.

FIG. 4 shows a second perspective view of the position sensor magnet unit from FIG. 2.

### DETAILED DESCRIPTION

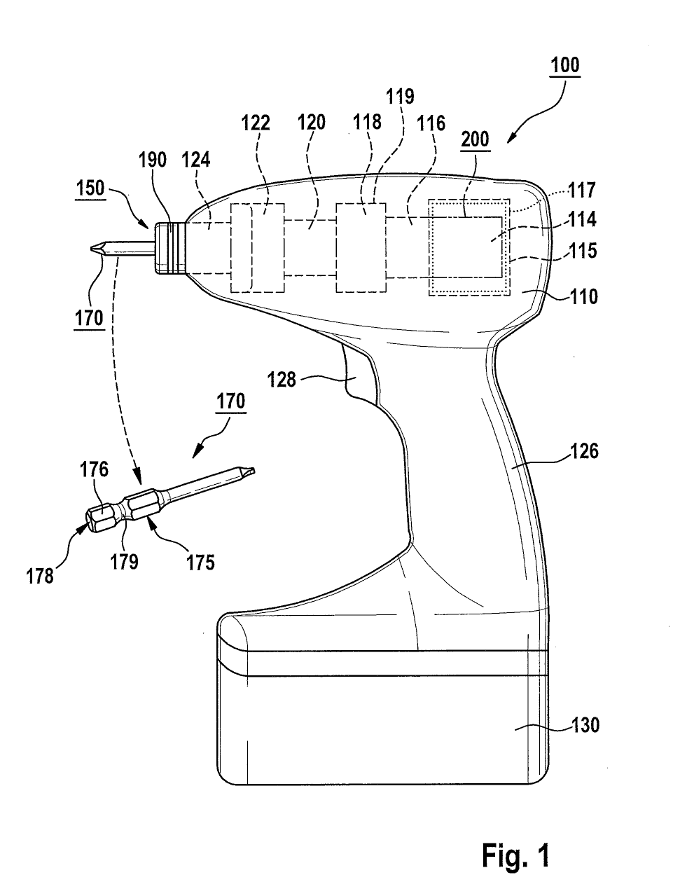

FIG. 1 shows an exemplary handheld power tool 100 which has a housing 110 including a handle 126. An electric drive motor 114, which is supplied with power by a battery pack 130, a gear 118, and an optional percussion mechanism 122 are illustratively situated in housing 110.

According to one specific embodiment, handheld power tool 100 is mechanically and electrically connectable to battery pack 130 for cordless power supply and has a tool receptacle 150 which is lockable via a locking sleeve 190, for example. This tool receptacle may be configured as a chuck or as a so-called insert-twist-fits (ITF) receptacle. Alternatively thereto, a non-detachably fastened tool may be configured on handheld power tool 100 instead of tool receptacle 150.

Handheld power tool 100 is configured as a cordless drill combo, as an example. It is, however, pointed out that the present invention is not limited to cordless drill combos, but may rather be used in different handheld power tools in which drive motor 114 may be used, e.g., in a screwdriver, a cordless drill, a percussion drill, a grinding machine, a saw, a milling machine, a buffing machine, etc., regardless of whether the handheld power tool is operable electrically, i.e., cordlessly using battery pack 130, or whether the handheld power tool is mains-operated.

Drive motor 114 illustratively has a stator and a rotor, or stator and rotor components, 117 and 200, respectively, and is operable, i.e., may be switched on and off, via a manual switch 128, for example, and is an electronically commutated, in particular a DC motor, in the present embodiment. Drive motor 114 may be controlled or regulated electronically in such a way that a reverse operation and input with regard to a desired rotational speed are implementable. The mode of operation and the configuration of an electronically commutated DC motor are sufficiently known from the related art so that a detailed description thereof is dispensed with for the sake of a concise description.

Drive motor 114 is connected via an associated motor shaft 116 to gear 118 which converts a rotation of motor shaft 116 into a rotation of a drive element 120, e.g., a drive shaft, provided between gear 118 and optional percussion mechanism 122. This conversion may take place in such a way that drive element 120 rotates in relation to motor shaft 116 at an increased torque but at a reduced rotational speed. Drive motor 114 is illustratively situated in a motor housing 115, and gear 118 in a gear housing 119, gear housing 119 and motor housing 115 being situated in housing 110 as an example.

Optional percussion mechanism 122, which is connected to drive element 120, is a rotary percussion mechanism, for example, which generates percussive angular momentums with high intensity and transfers them to an output shaft 124, e.g., an output spindle. An exemplary percussion mechanism, using which percussion mechanism 122 may be implemented, is described in DE 20 2006 014 850 U1 which is expressly referred to here and whose teachings are to be understood as a part of the present description, so that a detailed description of percussion mechanism 122 is dispensed with here for the sake of a concise description.

Tool receptacle 150, which is illustratively provided to receive insert tools having external polygonal couplings, is formed as an example on output shaft 124. Here, tool receptacle 150 is configured, as an example, to receive an insert tool 170 which is configured as a screwdriver bit and which has a shaft 176 having a coupling contour 175 which is formed in an axial end area 178 and which is formed by a polygonal, in particular hexagonal, cross section of shaft 176 and an external ring groove 179 which is provided there according to DIN 3126-E6.3, for example.

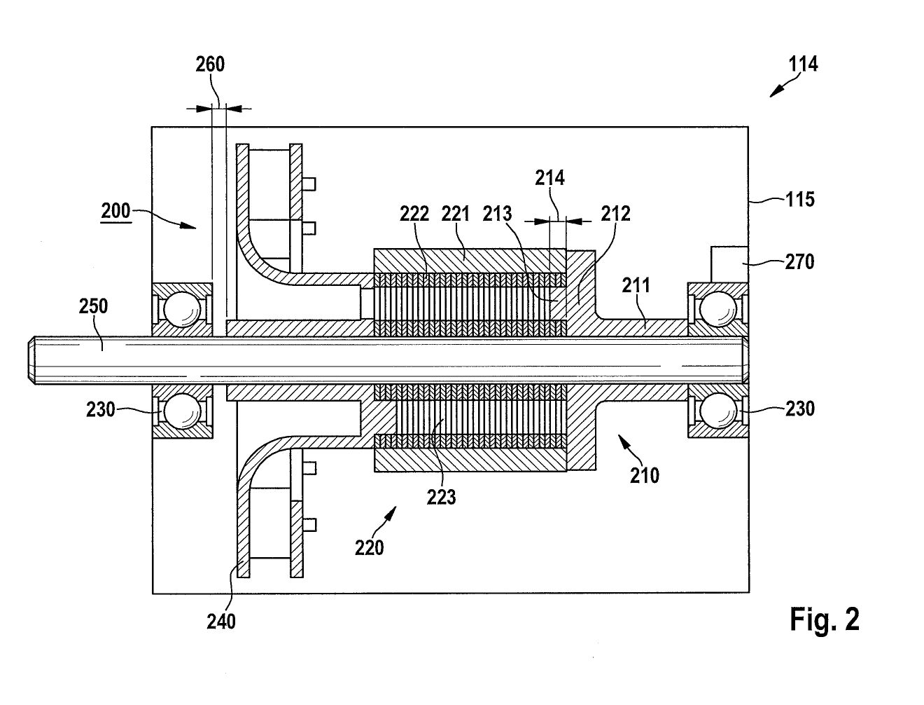

FIG. 2 shows drive motor 114 from FIG. 1 which is provided with motor housing 115 and which is assigned the rotor or rotor components 200 which illustratively have at least one rotor shaft 250 provided with a rotor or iron core 222, a drive magnet unit 220 situated on iron core 222, a position sensor magnet unit 210 situated on rotor shaft 250, and a revolving bell 240 fastened to rotor shaft 250, which are illustratively rotatably fixedly fastened against one another. In this case, rotor shaft 250 is rotatably held in two bearings 230 which are configured as rolling bearings in the present embodiment; as an alternative thereto, they are, however, also implementable with other types of bearings, e.g., friction bearings.

It is, however, pointed out that rotor shaft 250 is rotatably mounted in bearings 230, situated in motor housing 115, only as an example, and the present invention is not limited thereto. The rotor shaft may rather also be rotatably mounted at appropriate bearing points in housing 110 of handheld power tool 100 from FIG. 1, if it is implemented in the so-called “open-frame” design, for example. In the context of the present invention, the rotatable mounting of rotor shaft 250 may accordingly refer to a mounting in motor housing 115 as well as a mounting in housing 110 of handheld power tool 100 from FIG. 1, or to any other associated housing.

Drive magnet unit 220 has a ring magnet 221, as an example, which is also referred to as the main magnet and which is rotatably fixedly fastened to iron core 222. Axially aligned recesses or pass-through openings pass through iron core 222. In the present embodiment, iron core 222 is configured as a metal sheet package having a plurality of individual metal sheets or plates layered in the axial direction one on top of the other. The individual metal sheets may be punched, for example, pass-through openings 223 being possibly produced while the individual metal sheets are punched. During the composition of the individual metal sheets to form the metal sheet package implementing iron core 222, individual metal sheets are, for example, placed on top of one another in such a way that their pass-through openings 223 completely cover each other in the axial direction. It is, however, pointed out that iron core 222 is only configured as an example from individual metal sheets and the present invention is not limited thereto. Iron core 222 may rather be formed in general from a soft iron material and may also, for example, have a body which is pressed using powder metallurgy processes instead of individual metal sheets.

Axially between one of the two bearings 230 and drive magnet unit 220, position sensor magnet unit 210 is situated which illustratively includes a sleeve-like spacer 211 and a position sensor magnet 212 configured as a disk magnet. Position sensor magnet 212 has a rotor receptacle opening (215 in FIG. 4), through which rotor shaft 250 is guided, and is manufactured from a magnetic material which builds up a magnetic measuring field in the axial direction of rotor shaft 250, for example. To determine an angular position of rotor shaft 250, the magnetic measuring field may be detected by an associated sensor element 270, e.g., a Hall sensor, which is rotatably fixedly mounted in the area of the measuring field opposite rotor shaft 250. As an example, sensor element 270 is fastened on motor housing 115 in the area of a bearing 230 lying axially opposite position sensor magnet unit 210; it may, however, alternatively also be situated on a printed circuit board, which makes contact with bearing 230, or in another suitable location.

According to one specific embodiment, drive magnet unit 220 and position sensor magnet unit 210 or position sensor magnet 212 are connected to one another in a form-locked manner in the axial direction. For this purpose, axially aligned protrusions 213 are formed on, e.g., molded on, position sensor magnet 212 which mesh in a form-locked manner with axial pass-through openings 223 configured in iron core 222 and thus prevent a twisting of drive magnet unit 220 in relation to position sensor magnet 212. Protrusions 213 and pass-through openings 223 illustratively form here meshing fixing elements having matching geometric shapes.

To prevent the form-lock between position sensor magnet unit 210 and drive magnet unit 220 from detaching, an axial length 214 of axially aligned protrusion 213 on position sensor magnet 212 may be configured to be larger than a resulting axial clearance 260.

Illustratively, the total axial length of position sensor magnet unit 210, drive magnet unit 220, and revolving bell 240 is smaller than an axial distance between the two bearings 230 by the at least reduced, resulting axial clearance 260. In order to reduce, i.e., minimize, this axial clearance 260, which is based, in particular, on manufacturing tolerances, but is also production- or installation-related, for example, sleeve-like spacer 211 is formed on, e.g., molded on, position sensor magnet 212 which extends axially away from position sensor magnet 212 in the direction of bearing 230 which is adjacent to position sensor magnet unit 210.

In the present embodiment, sleeve-like spacer 211 and/or axially aligned protrusions 213 are configured, as an example, as a single piece with position sensor magnet 212; position sensor magnet 210 thus configured as a single piece may be configured as an injection-molded part. The shape of sleeve-like spacer 211 should be selected in such a way that sleeve-like spacer 211 is able to rotate freely with the other individual components which are mounted on rotor shaft 250. In the present embodiment, sleeve-like spacer 211 therefore has the shape of a hollow cylinder, but is not limited thereto.

As described above, sleeve-like spacer 211 makes it possible to safely and reliably ensure that rotor components 200 mounted in their housing 110 hold their positions over the service life of handheld power tool 100 from FIG. 1 and also in the case of axial stresses, e.g., if handheld power tool 100 is dropped. An axial displacement of this rotor component 200 between bearings 230 may also be safely and reliably prevented, so that the rotor components permanently have a unique, predefined axial position and hold this position even if axial forces act on rotor shaft 250.

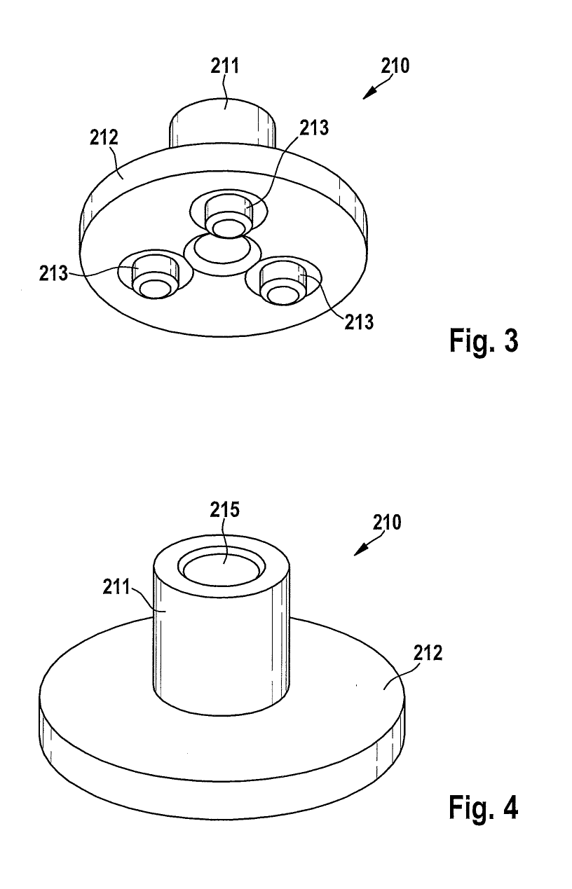

FIG. 3 shows position sensor magnet unit 210 from FIG. 2 which is illustratively configured as a single piece. FIG. 3 illustrates axially aligned protrusions 213, three axially aligned protrusions 213 being illustratively shown here.

FIG. 4 shows position sensor magnet unit 210 from FIGS. 2 and 3 to illustrate sleeve-like spacer 211 and rotor receptacle opening 215.

What is claimed is:

1. A handheld power tool, comprising:
an electronically commutated drive motor which is situated in an associated housing and which has a rotor provided with a rotor shaft, the rotor shaft being rotatably mounted in the associated housing having an axial clearance which is based at least partially on manufacturing tolerances; and
at least one position sensor magnet being rotatably fixedly mounted on the rotor shaft, wherein the position sensor magnet is assigned a sleeve-like spacer for reducing the axial clearance.

2. The handheld power tool of claim 1, wherein the position sensor magnet and the sleeve-like spacer are configured as a single piece.

3. The handheld power tool of claim 2, wherein the position sensor magnet, which is configured as a single piece with the sleeve-like spacer, is configured as a type of injection-molded part.

4. The handheld power tool of claim 1, wherein the position sensor magnet is connected to a drive magnet, which is rotatably fixedly situated on the rotor shaft, via meshing fixing elements which have mutually matching geometric shapes.

5. The handheld power, tool of claim 4, wherein the position sensor magnet has at least one axially aligned protrusion which meshes with an associated, axially aligned recess provided on the drive magnet, the protrusion and the recess being the fixing elements.

6. The handheld power tool of claim 5, wherein the axially aligned protrusion and the sleeve-like spacer are formed on axial ends of the position sensor magnet which face away from one another.

7. The handheld power tool of claim 4, wherein the matching geometric shapes form a form-lock to fasten the position sensor magnet on the drive magnet so that it is secured against twisting.

8. The handheld power tool of claim 5, wherein the rotor has an iron core on which the axially aligned recesses are formed as a type of axial pass-through opening.

9. The handheld power tool of claim 4, wherein the drive magnet is configured as a type of ring magnet.

10. An electronically commutated drive motor, comprising:
a drive motor;
an associated housing for housing the drive motor;
a rotor provided with a rotor shaft, the rotor shaft being rotatably mounted in the associated housing having an axial clearance which is based at least partially on manufacturing tolerances; and
at least one position sensor magnet rotatably fixedly mounted on the rotor shaft, wherein the position sensor magnet is assigned a sleeve-like spacer for reducing the axial clearance.
